(19) United States
(12) Patent Application Publication
(10) Pub. No.: US 2004/0100040 A1
(43) Pub. Date: May 27, 2004

(54) Penetration fire stopping seal for containment walls and floors

(76) Inventor: Michael Sakno, Toronto (CA)

Correspondence Address: David J French, Station D, PO Box 2486, Ottawa, K1P 5W6, CA

(21) Appl. No.: 10/380,692

(22) PCT Filed: Sep. 19, 2001
(86) PCT No.: PCT/CA01/01308

(30) Foreign Application Priority Data
Sep. 19, 2000 (CA) 2,319,876
Jul. 26, 2001 (CA) 2,354,220

(51) Int. Cl. F16J 15/52

(52) U.S. Cl. 277/635; 277/634; 277/637

(57) ABSTRACT

A sealing assembly for use at a building penetration to seal against airflow and the spread of fire includes a gasket (5) and a retaining plate (6). The gasket seals with a sealing contact against both the penetrating member (3) and the wall surfaces (4) adjacent to the penetration (2). The gasket is resiliently flexible and is positioned in a compressed state to ensure that a seal will be maintained, notwithstanding shifting of the penetrating member with respect to the penetration by frictional slippage between the seal and the adjacent wall surfaces. The compressed state of the gasket is maintained by the retaining plate, which is fastened to the penetrating member.

### FIELD OF THE INVENTION

This invention relates to systems for limiting the spread of fire, hot gases, water, and smoke within buildings structures. In particular, it relates to a fire stopping construction to be employed at penetrations, e.g. openings passing through containment separations that are formed in walls and floors in a building to permit the passage of pipes, conduits, wiring, and mechanical services etc. as penetrating members.

### BACKGROUND TO THE INVENTION

Throughout the years of building construction, steps have been taken to seal penetrations between floors and between rooms within a given area to delay in the spread of fire within the structure. These penetrations are typically made in separations to permit the passage of necessary services carried in pipes, electrical conduit, mechanical ventilation or communication wiring within the building.

The traditional procedure for sealing penetrations in floors and walls has been to pack the cavity around the penetrating item (e.g. a conduit, using conduit as an example) with mineral wool and then to apply a fire resistant-based caulking over the mineral wool. This caulking bonds to the separation and penetrating member providing a seal. One objective is to close-off gaps through which flame and hot gases might pass. Other objects are to reduce sound transmission and contain airflow that would disrupt heating and ventilation. A further object is to reduce water damage occurring in the course of construction or during the accidental or intentional activation of the fire sprinkler system.

A difficulty with existing systems is that pipes and conduits passing through penetrations are rarely perfectly aligned with the center of the penetration. An off-center conduit can still be packed with mineral wool and sealed with caulking. However, during the life of a building construction floors may be displaced by dimensions of as much as on the order of a centimeter, or more. This will occur with floor loading and building creep. Additionally, penetrating elements such as pipes and conduits may be displaced laterally or axially due to seismic activity or ambient vibration. If a fire stopping treatment has already been applied to a conduit, which is subsequently displaced laterally, then at the very minimum, the integrity of the caulking seal will have been lost. Further, with sufficient lateral displacement, the mineral wool will no longer provide a complete block through the penetration against the passage of smoke, and eventually flames.

In the case of plastic piping, it is known to provide an intumescent material around plastic pipe, either adjacent or within the penetration through which the plastic piping is being passed. Under fire conditions, a temperature rise within the pipe will soften the plastic and cause the intumescent material to expand. This expansion of the intumescent wrappings of material will pinch the softened pipe closed and delay the spread of fire. It is known to provide such pipe-collapsing intumescent wrappings both within the penetration in the floor, and in the space directly adjacent to the floor. In the former case, the sidewalls of the penetration contain the expansion of the intumescent material and cause the pipe to be crushed. In the latter case, an the external containment sleeve is typically placed radially around the intumescent material leaving it no other alternative upon expansion other than to crush the pipe before being expressed out of gaps in the containment sleeve.

The present invention is directed to a fire-stopping system that will provide a seal or barrier to the passage of smoke and flame even in cases where there is lateral or vertical movement between the surface containing a penetration and the penetrating member passing there through.

The invention in its general form will first be described, and then its implementation in terms of specific embodiments will be detailed with reference to the drawings following hereafter. These embodiments are intended to demonstrate the principle of the invention, and the manner of its implementation. The invention in its broadest and more specific forms will then be further described, and defined, each of the individual claims which conclude this Specification.

### SUMMARY OF THE INVENTION

According to one aspect of the invention, a sealing gasket is provided for intimately surrounding a penetrating member that is passing through a building floor or wall penetration. This gasket, preferably made out of a fire resistant material, is located directly adjacent to the penetration through which the penetrating member is passing and, being made of elastic material, bears resiliently against the building structure surrounding the penetration. The gasket is not attached to the surrounding structure and is free to accommodate both lateral and axial movement of the penetrating member with respect to the penetration, while maintaining a seal at the penetration that will limit the spread of flames. The gasket serves as a seal between the penetrating member, e.g., the pipe, and the building structure surrounding the penetration.

A preferred form of fire-resistant gasket that bears resiliently against the surface of the floor or wall surrounding the penetration preferably is made of a resilient sheet with circular corrugations that provide axial resilience within the gasket. The gasket is, as appropriate, of a shape that will surround the penetrating member. It may therefore have an internal or central hole that matches or is slightly smaller than the diameter of the penetrating member, within the elastic limit of the resilient material of the gasket. This central hole is intended to provide a seal between the gasket and the penetrating member. It need not necessarily be circular. It need only,, conform to the outer surface of the penetrating mender against which it is providing a sealing fit.

In order to maintain the gasket in resilient contact with the surrounding building structure adjacent to the penetration, its inner boundary is fixed with respect to the penetrating member. According to one preferred variant a retaining plate is preferably fitted over the gasket and engaged to the penetrating member. The retaining plate includes an internal or central hole through which the penetrating member passes. While generally planar, this retaining plate may be slightly domed or conical in its general cross-sectional outline in order to provide strength to resist inversion. Resistance to inversion may be increased by including around the outside periphery of the retainer a circumferential flange that is more conically angled than the plate.

This plate need not conform precisely to the gasket. Its function is to fix the upper, inner portion of the gasket with respect to the penetrating member so that the gasket will bear resiliently against the adjacent surface of the building structure. It can do so both by pressing against the resilient gasket around its central hole so as to compress its corrugated ridges, and also by causing the elastically resilient periphery of the gasket to be deflected outwardly around its circumferential border. This latter effect may eventually be achieved by contact between the outer periphery of the retaining plate and the outer region of the gasket, just inside its ultimate outside boundary. A further function of the retaining plate is to protect the gasket from a fire hose stream during a fire.

By reason of the compressibility of the gasket in the axial direction of the penetrating member, flexures occurring between the penetrating member and the building structure in the axial direction, e.g., subsidence of the floor, can be accommodated within the range of resilience of the gasket. Further, because the gasket is not fastened to the surface surrounding the penetration, lateral displacements between the penetrating member and such surfaces can be accommodated without loss of the fire stopping seal.

One of the functions of the retaining plate is to maintain the gasket in position pressed against the building structure. The plate is able to provide a thrust against the gasket by being coupled to the penetrating member. Any type of coupling means between the retaining plate and the penetrating member will suffice. This includes welding, the use of adhesives or standard fasteners. Further, the inner rim of the gasket itself may be coupled to the penetrating member, as by an adhesive or screw fastener.

A preferred feature of the retaining plate, particularly suited for use with circular pipe and more particularly metallic pipe e.g. copper, is the provision around the border * of the internal hole within the retaining plate of a series of locking tabs. The retaining plate of this type relies upon the engagement structure commonly found in a “push-nut”. The tabs, in the form of inwardly directed fingers, effect an interference fit against the pipe when bent down into the pipe. In the case of a galvanized sheet metal retaining plate adapted to the fit around copper pipe, these tabs may have an interference overlap with the pipe, when pressed into the plane of the plate, of 50 thousandths of an inch. During installation, these tabs are bent slightly out of the plane of the plate so as to allow the retaining plate to be slid along the length of the pipe in either direction. Once in position, the tabs are depressed into engagement with the pipe.

The installation procedure using retaining plates provided with such locking tabs is to slide the plate against a gasket that is already in place, positioning it to resiliently compress the gasket. In order to fasten the retaining plate in position bearing against the gasket, several tabs are then depressed into an interfering, locking engagement with the pipe. To lock the retainer against displacement in two directions, first two or three tabs may be forced past a parallel orientation, to be deflected downwardly in the opposite direction to the balance of the upwardly bent tabs. By limiting the downward deflection of these tabs, their locking engagement with the pipe can be achieved and then preserved once a sufficient number of tabs angled in the opposite direction have also been pressed into locking engagement with the pipe.

While the gasket may be corrugated in cross-section to provide resilience, the gasket may also be in the form of a compressible body, as for example a panel of resiliently compressible closed cell foam.

Further, the retaining plate may be made in parts which, when assembled will be fixed with relation to the penetrating member, while bearing against the gasket to compress, or partially compress, the gasket against the building surface. A retaining plate made, for example, in two parts may include clamping faces drawn together by fasteners so as to clamp onto the penetrating member.

The role of the gasket is to provide isolations across separations, and particularly fire stopping within a building structure. For this latter purpose it is highly desireable that the gasket be fire resistant. “Fire resistant” means the capacity to continue to provide a sealing function in the presence of heat and flames for a sufficient period of time to meet the fire-stopping criteria for a structure. Underwriter Laboratories provides a standard, UL 1479, which rates afire resistant structure according to its capacity to resist a rising temperature for a given period of time e.g., to a 30 minutes, one hour, two hour and three-hour rating. Similar standards are published in Canada under CAN 4 S115, in the United Kingdom under BS 476, part 20, and in Europe under standard PDN 236. Any gasket material that meets the minimum requirements of any of the standards used by the industry is considered to qualify as being “fire resistant”.

As an additional feature, the gasket may be made of an intumescent material. A suitable intumescent material is exfoliating graphite in a suitable binding material such as polyvinyl chloride [PVC] or chlorinated polyvinyl chloride [CPVC]. Other suitable intumescent materials may be employed as well. By incorporating into the gasket a capacity to intumesce under heat, the sealing performance of the gasket system of the invention will be enhanced under extreme temperature conditions. Once they gasket intumesces, its sealing action will no longer be dependent upon its resiliency. Instead, the intumescent material will swell-up and block all passages through which smoke and flames might otherwise pass at the penetration. This is an additional, though very useful, feature for the gasket to embody.

The foregoing summarizes the principal features of the invention and some of its optional aspects. The invention may be further understood by the description of the preferred embodiments, in conjunction with the drawings, which now follow.

### SUMMARY OF THE FIGURES

FIG. 1 is a cross-sectional side view through a penetration within a concrete floor of a building, having passing there through a vertical pipe and having the gasket and retaining plate of the invention attached to the pipe in position adjacent to the penetration.

FIG. 2 is a cross-sectional oblique view through a partitioning wall within a building having a penetration there through including a series of conduits for the passage of electrical wiring, a generally rectangular retaining plate and gasket surrounding the conduit and including additional, circular retaining plates as in FIG. 1 encircling pipes within the rectangular retaining plate to retain gasket material present beneath such plates.

FIG. 3 is an exploded cross-sectional side view of a gasket and retaining plate before the gasket is compressed by the retaining plate.

FIG. 4 is an exploded cross-sectional detailed side view of FIG. 1 with the gasket compressed by the retaining plate.

FIG. 5 is a cross-sectional side view of a bathtub installed on a floor with a drainpipe sealed on the underside of the floor by a plate and gasket according to the invention. shape of a disc held by a retaining member that is divided into two parts which may be clamped to a penetrating member.

FIG. 6A is a plan view of the clamping portions of FIG. 6, showing a bolt on one side as one example of a fastener, and a barbed fastener on the other side as a further example.

FIG. 6B is a detailed close-up cross-sectional view of a barbed fastener.

### DESCRIPTION OF THE PREFERRED EMBODIMENT

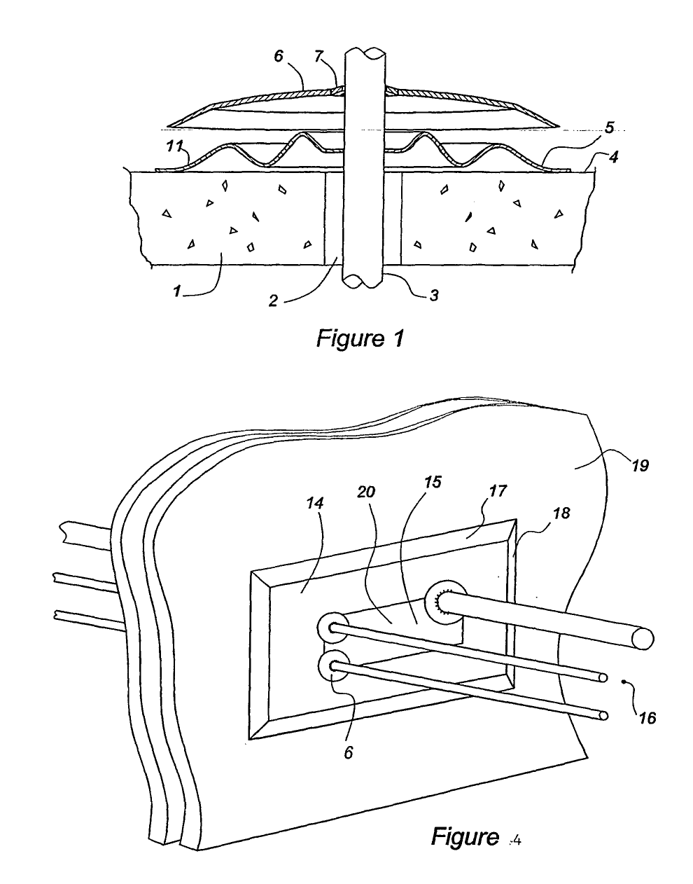

In FIG. 1 a floor 1 has a hole- pierced through it, serving as a penetration 2. Within this penetration 2 passes a copper pipe 3 that is generally vertically oriented. Adjacent the top surface 4 of the floor 1 a gasket 5 in a state of resilient compression spans the penetration, sealing-off the penetration. The gasket 5 is held in place by a retainer plate 6 that is attached to the pipe 4 by tabs 7.

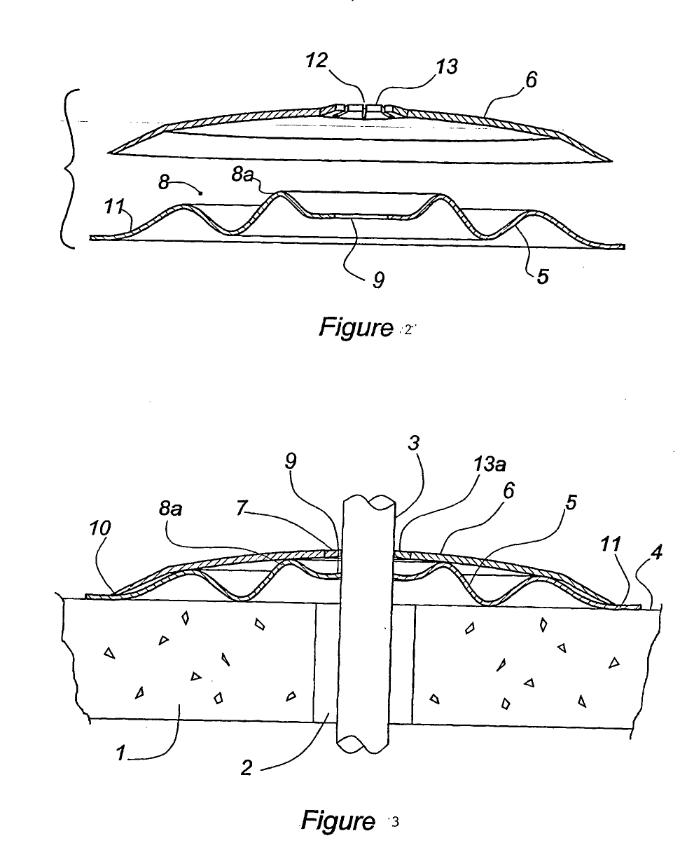

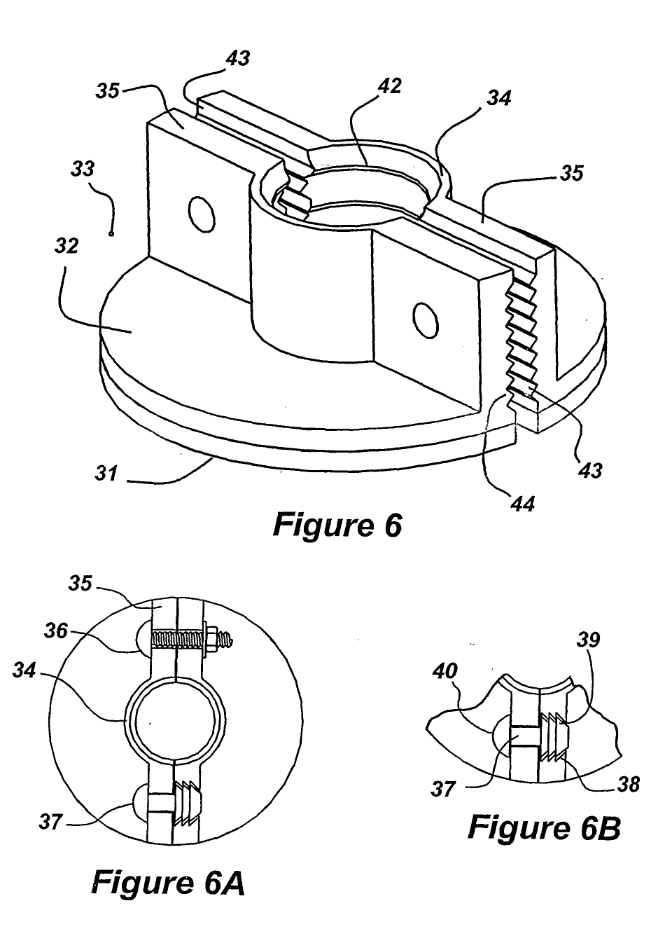

As shown in FIGS. 3 and 4, the gasket 5 has a series of circular corrugations 8 set into its slightly domed surface that assist in providing it with a resilient compressibility. Additionally, the outer periphery of the gasket 5 is elastically splayed outwardly against the floor surface 4 due to compression from the plate 6. The retainer plate 6 contacts the gasket 5 both around its inner corrugation 8A, near the gasket central opening 9 where the gasket intimately seals against the pipe 2; and optionally just within the boundary 10 of the outwardly-directed, elastic flange 11 on the gasket 5. Thus, if the floor were to drop by a small dimension, the outward periphery of the flange would follow the floor down, Additionally, the resiliently compressed corrugations 8 within the gasket would cause the gasket 5 to continue to bear against the floor surface 4, to the limit of Retaining plate 6, preferably made of galvanized steel, is locked in position against the pipe 3 by a series of circumferential tabs 13, 13A that border the inside hole 12 within the retainer plate 6. Some of these tabs 13A have been a depressed downwardly in FIG. 3 from their upwardly inclined position 13 in FIG. 2, pressed into the pipe 3 with a lesser but still upward inclination. The result is to provide a jamming effect which fastens the retaining plate 6 in position. In FIGS. 6, 6A and 6B a disc-shaped, open or closed-cell foam gasket 31 or resiliently compressible material is fitted beneath a rigid plate 32 that is part of a two-part retaining member 33. Each of the parts of retaining member 33 include a penetrating member-embracing collar portion 34 and coupling plates 35. A bolt 36 may pass between the coupling plates 35 to draw the collat portions 34 tightly against a penetrating member 3 (not shown in FIG'S. 6. 6A, 6B). The collar portions 34 may have ribbed inner surfaces 42 for engaging a penetrating member. The faces 43 of the coupling plates 35 may have inter-engaging ribs 44 to ensure stability and stiffness when they are coupled together.

As an alternative fastener a barbed pin 37 formed in a coupling plate 35 to provide a snap-fit engagement. A head 40 prevents the pin 37 from being pulled-through the hole through which it passes.

In FIG. 4 a retaining plate 14 with a rectangular opening 15 includes three pipes 16 passing there through. To provide fire stopping under these circumstances, the gasket 17 is more generally rectangular in formation, but still includes an outer, elastically bent peripherally flange 18 and resiliently compressible corrugations and a planar central region 20. The rectangular retaining plate 14 is shaped to surface of the bordering the wall 19 through which the conduits 16 pass. Within the planar central region 20 holes permit passage of the three pipes 16 with a tight, sliding fit. Although the retaining plate 14 of FIG. 4 could be specifically shaped to engage with such three pipes 16, conveniently, circular retaining plates 6 as in FIG. 1 may be fitted individually over each of the three pipes 16. These plates 6 bear against the central planar region 20 of the gasket 17 to contain ;;he gasket 17 and assist, along with the retaining plate 14, in causing the gasket 17 to bear resiliently against the wall 19.

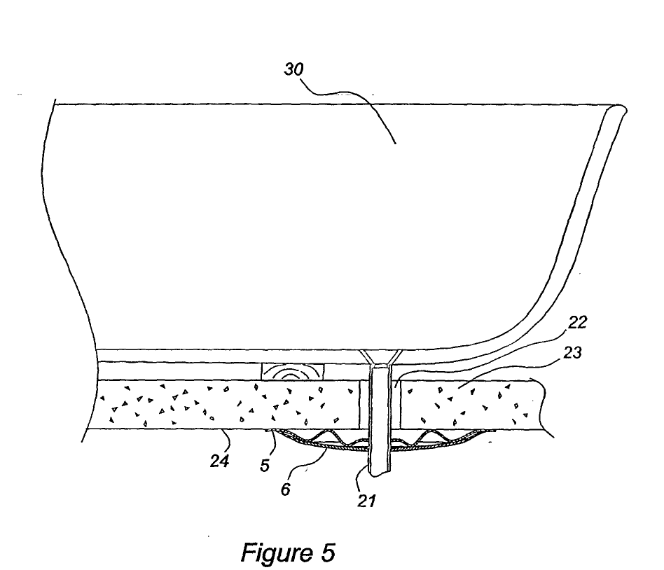

An advantage of a fire-stopping plate and gasket of the present invention is that it may conveniently be installed on the underside surface of a floor i.e. against a ceiling. In FIG. 5, a bathtub 30 is shown in place with a bathtub drainpipe 21 extending downwardly through a penetration 22 in a concrete floor 23 providing a ceiling surface 24. When this drain pipe 21 has been fitted in place, extending downwardly through the penetration 22 in a concrete floor 23, the gasket 5 and retainer plate 6 of the invention may be slid upwardly on the drain pipe 21 of the bathtub 30 until they are in position against the ceiling surface 24. This provides an extremely convenient manner for sealing-off bathtubs from the underside of a floor/ceiling.

Suitable materials for making the preformed gasket 5 include a polymer from the group composed of acrylate polymers, natural rubbers, polychloroprene, styrene butadiene copolymers, polyisoprene, butadiene acrylonitrile copolymers, polyvinyl chloride, polyvinyl acetate, polyethylene terephthalate, polyethylene, polypropylene, polystyrene, latex, silicone, acrylate and methacrylate polymers, and copolymers, polybutadiene acrylate, styrene butadiene copolymers, natural rubbers, butadiene acrylonitrile copolymers, polyvinylidene flouride, urethane elastomers, polyamide, polychlorodrene, polyisoprene, and polybutadiene and combinations and mixtures thereof. The gasket material may either be foamed (open or closed cell) or solid.

In the case where an intumescent filler is incorporated into the matrix or carrier material of the gasket, suitable fillers include acid intercalated graphite and granular hydrated alkali metal silicate and compatible combinations and mixtures thereof. Additionally, the following endothermic compounds may be present: magnesium ammonium phosphate, hydrated zinc borate, calcium sulfate, alumina trihydrate, magnesium hydroxide, ZnB, encapsulated H sub 20.

Conclusion

The foregoing has constituted a description of specific embodiments showing how the invention may be applied and put into use. These embodiments are only exemplary. The invention in its broadest, and more specific aspects, is further described and defined in the claims which now follow.

These claims, and the language used therein, are to be understood in terms of the variants of the invention which have been described. They are not to be restricted to such variants, but are to be read as covering the full scope of the invention as is implicit within the invention and the disclosure that has been provided herein.

The embodiments of the invention in which an exclusive. property or privilege is claimed are defined as follows:

1. A fire stop assembly comprising a preformed fire-resistant gasket for intimately surrounding a penetrating member that is passing through a building separation, said gasket being located directly adjacent to the penetration through which the penetrating member is passing and bearing resiliently against the building structure surrounding the penetration without being affixed to provide a seal, whereby the gasket is free to accommodate both lateral and axial movement of the penetrating member with respect to the penetration and building separation, while maintaining a seal between the penetrating member and the building separation surrounding the penetration to limit the spread of smoke and flames, said assembly further comprising retention means for retaining the gasket in said position on said penetrating member.

2. A fire stop assembly as in claim 1 wherein said gasket is made of a resilient sheet with corrugations that provide enhanced resilience within the gasket whereby displacements occurring between the penetrating member and the building structure can be accommodated within the range of resilience of the gasket, both in the direction of the penetrating member and laterally without loss of the fire stopping seal.

3. A fire stop assembly as in claim 1 that conforms to the exterior shape of the penetrating member wherein the gasket is generally slightly smaller than the outside dimension of the penetrating member and, within the elastic limit of the resilient material of the gasket, to provide a sealing fit between the gasket and the penetrating member.

4. A fire stop assembly as in claims 1, 2 or 3 in combination with a retaining plate as the retention means, said plate being shaped and dimensioned to fit over the gasket and being engaged to the penetrating member to cause the gasket to bear resiliently against the adjacent surface of the building structure by pressing against the resilient gasket.

5. A fire stop assembly as in claim 4 wherein the gasket is provided with an elastically resilient periphery which is deflected outwardly around its circumferential border by reason of the compression of the gasket in the axial direction of the penetrating member by the retaining plate.

6. A fire stop assembly as in claims, 4 wherein the retaining plate is slightly domed or conical in its general cross-sectional outline and incorporates around the outside periphery of the retaining plate a circumferential flange which is more conically angled than the plate in order to provide strength to resist inversion.

7. A fire stop assembly as in claim 4 wherein the retaining plate includes at least one internal hole through which the penetrating member passes and connecting means positioned at the border of said hole to connect the retaining plate to the penetrating member.

8. A fire stop assembly as in claim 7 wherein said connecting means comprises a plurality of inwardly directed tabs or barbs deployed around the border of the internal hole within the retaining plate, which tabs effect an interference fit against the penetrating member provide a locking engagement with said member.

9. A fire stop assembly as in claim 7 wherein said connecting means comprises a welded junction.

10. A fire stop assembly as in claim 7 wherein said connecting means comprises a mechanical fastener.

11. A fire stop assembly as in claims 1, 2, 3, 4, 5, 6, 7, 8, 9, or 10, wherein the retaining means is coupled to the penetrating member causing the gasket to maintain a compressive seal against the separation wherein the penetrating member can move both longitudinally and laterally in response to movement of the penetrating member with respect to the separation while still meeting the test standards of any of UL 1479, UL 2079, Can 4 s115, under fire test conditions.
